(19) United States
(12) Patent Application Publication
(10) Pub. No.: US 2025/0159118 A1
(43) Pub. Date: May 15, 2025

(54) PROJECTION DEVICE

(71) Applicant: GUANGZHOU LUXVISIONS INNOVATION TECHNOLOGY LIMITED, GUANGZHOU (CN)

(72) Inventors: Yi-Wei Liu, Guangzhou (CN); Che-Kai Chang, Guangzhou (CN); Chun-Li Chen, Guangzhou (CN)

(73) Assignee: GUANGZHOU LUXVISIONS INNOVATION TECHNOLOGY LIMITED, GUANGZHOU (CN)

(21) Appl. No.: 18/746,070

(22) Filed: Jun. 18, 2024

(30) Foreign Application Priority Data
Nov. 15, 2023 (CN) 202311522270.4

(51) Int. Cl. H04N 9/31

(52) U.S. Cl. CPC H04N 9/3158; H04N 9/3155

(57) ABSTRACT

A projection device including a first micro light emitting diode (micro LED) panel, a second micro LED panel, a color combiner prism, and a projection lens is provided. The first micro LED panel includes multiple first micro LEDs arranged in an array. The second micro LED panel includes multiple second micro LEDs and multiple third micro LEDs arranged in an array. The first micro LEDs, the second micro LEDs, and the third micro LEDs respectively emit a first color light, a second color light, and a third color light that are different from each other. The color combiner prism is disposed on a path of the first color light, the second color light, and the third color light to generate an image light. The projection lens is disposed on the path of the image light, and the image light passes through the projection lens and then exits the projection device.

### CROSS-REFERENCE TO RELATED APPLICATION

This application claims the priority benefit of China application serial no. 202311522270.4, filed on Nov. 15, 2023. The entirety of the above-mentioned patent application is hereby incorporated by reference herein and made a part of this specification.

### BACKGROUND

### Technical Field

The disclosure relates to an optical device, and in particular to a projection device.

### Description of Related Art

In current projection devices on the market, multiple discrete light sources and multiple light combining elements are used to generate images. The light combining elements are arranged in a staggered manner, resulting in a large size and a high cost of the projection device. Therefore, how to eliminate the use of multiple light combining elements, reduce the size of the projection device, and reduce the cost of the projection device has become an issue to be solved.

### SUMMARY

The disclosure provides a projection device which only needs a single light combining element, having a small size and a low cost.

According to an embodiment of the disclosure, a projection device is provided, including a first micro light emitting diode (micro LED) panel, a second micro LED panel, a color combiner prism, and a projection lens. The first micro LED panel includes multiple first micro LEDs arranged in an array. The second micro LED panel includes multiple second micro LEDs and multiple third micro LEDs arranged in an array. The first micro LEDs, the second micro LEDs, and the third micro LEDs respectively emit a first color light, a second color light, and a third color light that are different from each other. The color combiner prism is disposed on a path of the first color light, the second color light, and the third color light to generate an image light. The projection lens is disposed on a path of the image light, and the image light passes through the projection lens and then exits the projection device.

Based on the above, in the projection device provided in an embodiment of the disclosure, the first micro LED panel includes the first micro LEDs providing the first color light. The second micro LED panel includes the second micro LEDs providing the second color light and the third micro LEDs providing the third color light. The first micro LED panel and the second micro LED panel are disposed on both sides of the color combiner prism to generate the image light by utilizing the light-combining function of the color combiner prism. Only one light combining element is required to be provided in the projection device, so the projection device has a small size and a low cost.

To make the aforementioned more comprehensible, several embodiments accompanied with drawings are described in detail as follows.

### BRIEF DESCRIPTION OF THE DRAWINGS

FIG. 1 is a schematic diagram of a projection device according to an embodiment of the disclosure.

FIG. 2A is a schematic planar diagram of a first micro LED panel and a second micro LED panel according to an embodiment of the disclosure.

FIG. 2B is a schematic cross-sectional diagram of the first micro LED panel and the second micro LED panel of FIG. 2A.

FIG. 2C is a schematic diagram of a projection device according to an embodiment of the disclosure.

FIG. 3A is an exploded diagram illustrating a schematic planar diagram of a first micro LED panel and a second micro LED panel according to an embodiment of the disclosure.

FIG. 3B is a schematic cross-sectional diagram of the first micro LED panel and the second micro LED panel of FIG. 3A.

### DESCRIPTION OF THE EMBODIMENTS

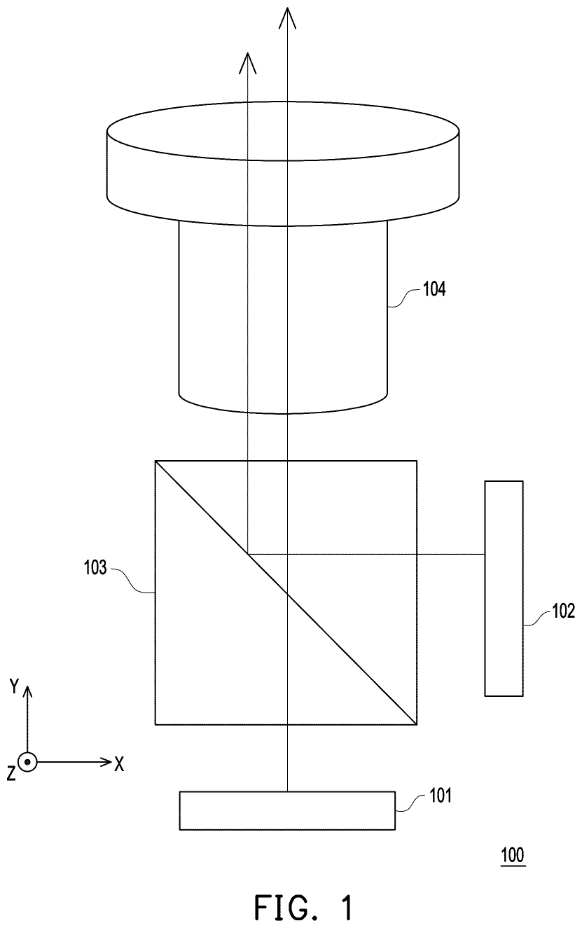

FIG. 1 is a schematic diagram of a projection device according to an embodiment of the disclosure A projection device 100 includes a first micro light emitting diode (micro LED) panel 101, a second micro LED panel 102, a color combiner prism 103, and a projection lens 104. The first micro LED panel 101 is disposed on an X-Z plane, and the second micro LED panel 102 is disposed on a Y-Z plane.

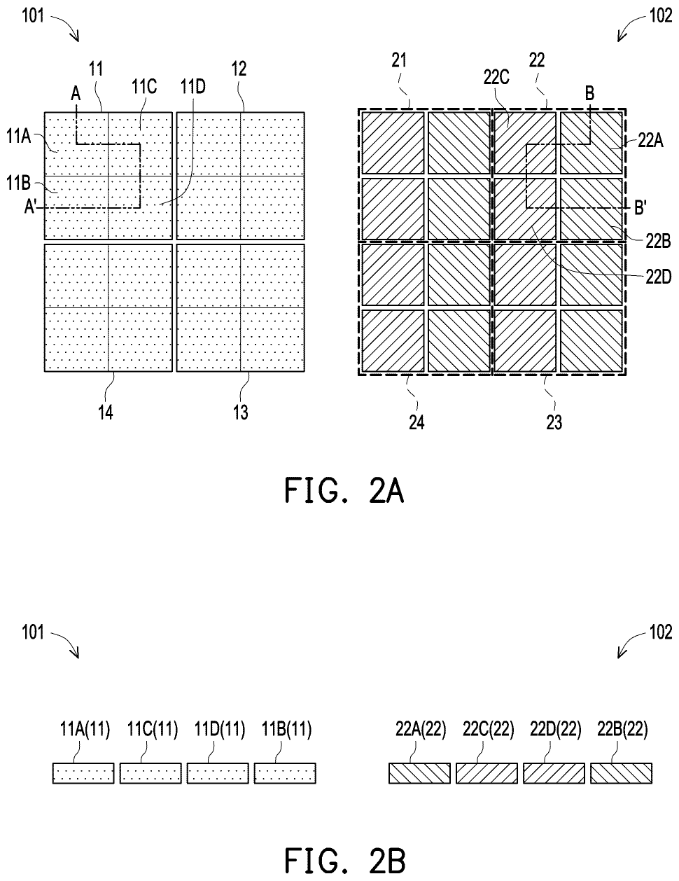

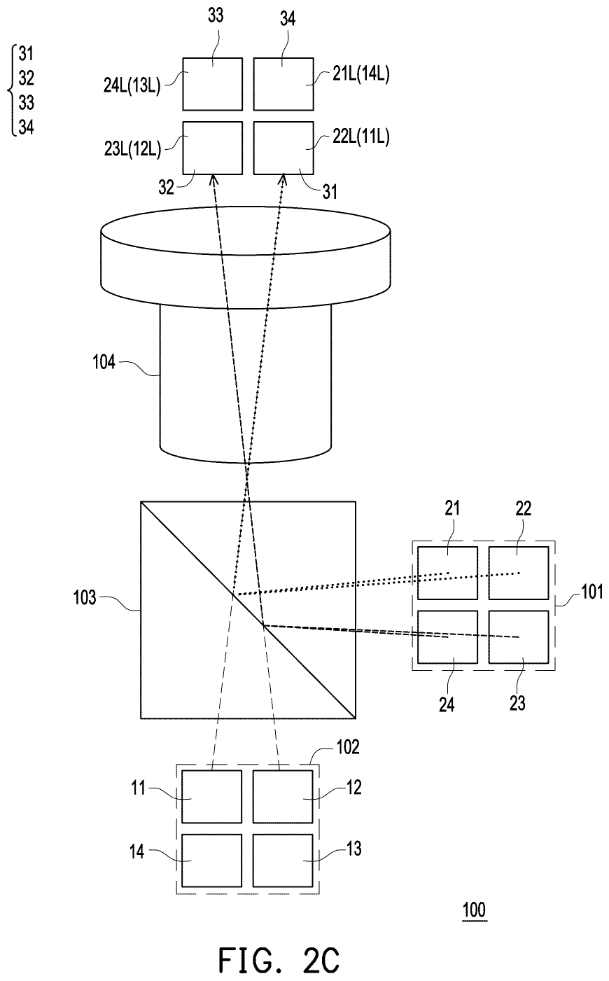

Referring to FIG. 1, FIG. 2A, FIG. 2B, and FIG. 2C at the same time, the first micro LED panel 101 includes multiple first pixel units 11, 12, 13, and 14 arranged in an array. Each of the first pixel units 11, 12, 13, and 14 includes multiple first micro LEDs for emitting a first color light. Specifically, as shown in FIG. 2A, the first pixel unit 11 includes four first sub-pixel units 11A, 11B, 11C, and 11D. Each of the first sub-pixel units 11A, 11B, 11C, and 11D includes at least one of the first micro LEDs for emitting the first color light. That is to say, the first pixel unit 11 includes at least four of the first micro LEDs. Likewise, each of the first pixel units 12, 13, and 14 also includes at least four of the first micro LEDs. The first color light emitted from the first pixel units 11, 12, 13, and 14 travels toward the color combiner prism 103.

The second micro LED panel 102 includes multiple second pixel units 21, 22, 23, and 24 arranged in an array. Each of the second pixel units 21, 22, 23, and 24 includes multiple second micro LEDs for emitting a second color light and multiple third micro LEDs for emitting a third color light. Specifically, as shown in FIG. 2A, the second pixel unit 22 includes four second sub-pixel units 22A, 22B, 22C, and 22D. Each of the second sub-pixel units 22C and 22D includes at least one of the second micro LED for emitting the second color light. Each of the second sub-pixel units 22A and 22B includes at least one of the third micro LED for emitting the third color light. That is, the second pixel unit 22 includes at least two of the second micro LEDs and at least two of the third micro LEDs. Likewise, each of the second pixel units 21, 23, and 24 also includes at least two of the second micro LEDs and at least two of the third micro LEDs. The second color light and the third color light emitted from the second pixel units 21, 22, 23, and 24 travel toward the color combiner prism 103.

In this embodiment, each of the first pixel units 11, 12, 13, and 14 includes at least four of the first micro LEDs arranged in an array for emitting the first color light. Each of the second pixel units 21, 22, 23, and 24 includes at least two of the second micro LEDs arranged in an array for emitting the second color of light and at least two of the third micro LEDs for emitting the third color light, but the disclosure is not limited thereto. In the embodiments of the disclosure, each of the first pixel units 11, 12, 13, and 14 may include at least one of the first micro LED. Each of the second pixel units 21, 22, 23, and 24 may include at least one of the second micro LED and at least one of the third micro LED. In this embodiment, the first color light is a red light. The second color light is a green light. The third color light is a blue light. However, the disclosure is not limited thereto.

Referring to FIG. 2C, by configuring the color combiner prism 103 on a path of the first color light, the second color light, and the third color light, a light 11L generated by the first pixel unit 11 and a light 22L generated by the second pixel unit 22 are combined to form a first sub-pixel 31 of an image light 30. The light 11L is the first color light, and the light 22L is a mixture of the second color light and the third color light. Therefore, the first sub-pixel 31 of the image light 30 may include the first color light, the second color light, and the third color light. A light 12L generated by the first pixel unit 12 and a light 23L generated by the second pixel unit 23 are combined to form a second sub-pixel 32 of the image light 30. The light 12L is the first color light, and the light 23L is a mixture of the second color light and the third color light. Therefore, the second sub-pixel 32 of the image light 30 may include the first color light, the second color light, and the third color light. A light 13L generated by the first pixel unit 13 and a light 24L generated by the second pixel unit 24 are combined to form a third sub-pixel 33 of the image light 30. The light 13L is the first color light, and the light 24L is a mixture of the second color light and the third color light. Therefore, the third sub-pixel 33 of the image light 30 may include the first color light, the second color light, and the third color light. A light 14L generated by the first pixel unit 14 and a light 21L generated by the second pixel unit 21 are combined to form a fourth sub-pixel 34 of the image light 30. The light 14L is the first color light, and the light 21L is a mixture of the second color light and the third color light. Therefore, the fourth sub-pixel 34 of the image light 30 may include the first color light, the second color light, and the third color light. That is, each of the first to fourth sub-pixels 31, 32, 33, and 34 of the image light 30 may include the first color light, the second color light, and the third color light. Accordingly, when a first control module is disposed in the first micro LED panel 101 and a second control module is disposed in the second micro LED panel 102, in which the first control module may independently control a current amount of each of the first sub-pixel units and the second control module may independently control a current amount of each of the second sub-pixel units, a luminance and a chromaticity of each of the first to fourth sub-pixels 31, 32, 33, and 34 of the image light 30 may be changed according to a current of each of the first sub-pixel units and a current of the second sub-pixel unit. The image light 30 with controllable luminance and chromaticity further passes through the projection lens 104 and then exits the projection device 100.

In an embodiment of the disclosure, the first micro LED panel 101 includes the first micro LEDs for providing the first color light. The second micro LED panel 102 includes the second micro LEDs for providing the second color light and the third micro LEDs for providing the third color light. The first micro LED panel 101 and the second micro LED panel 102 are disposed on both sides of the color combiner prism 103, and the image light 30 is generated by utilizing a light-combining function of the color combiner prism 103. Only one color combiner prism 103 is required to be disposed in the projection device 100, so the projection device 100 has a small size and a low cost.

It should also be noted that, referring to FIG. 2A and FIG. 2B, FIG. 2B shows a schematic cross-sectional diagram along a dotted line AA′ on the first micro LED panel 101 in FIG. 2A and a dotted line BB′ on the second micro LED panel 102 in FIG. 2A. In this embodiment, the second sub-pixel units 22C and 22D emitting the second color light and the second sub-pixel units 22A and 22B emitting the third color light are disposed in the same layer. Therefore, the second micro LEDs in the second sub-pixel units 22C and 22D and the third micro LEDs in the second sub-pixel units 22A and 22B are disposed in the same layer. In other words, as shown in FIG. 2A, a total area of the second sub-pixel units 22C and 22D in the second pixel unit 22 having the second micro LEDs plus a total area of the second sub-pixel units 22A and 22B in the second pixel unit 22 having the third micro LEDs is substantially equal to a total area of the first sub-pixel units 11A, 11B, 11C, and 11D in the first pixel unit 11 having the first micro LEDs.

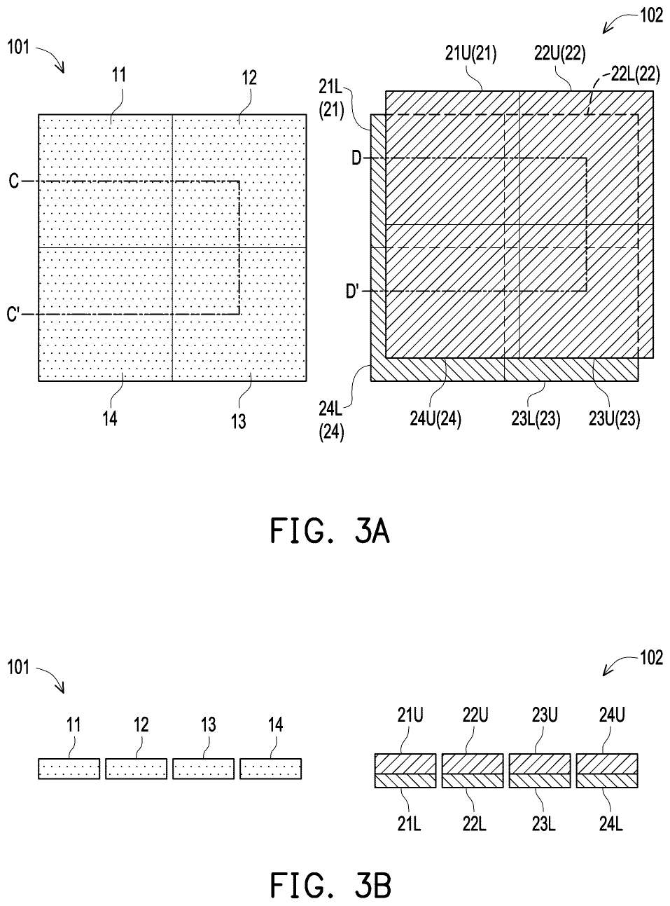

In contrast, referring to FIG. 3A and FIG. 3B, FIG. 3A shows an exploded diagram of a planar diagram of the first micro LED panel 101 and the second micro LED panel 102 according to another embodiment of the disclosure. FIG. 3B shows a cross-sectional diagram along a dotted line CC′ on the first micro LED panel 101 in FIG. 3A and a dotted line DD′ on the second micro LED panel 102 in FIG. 3A.

In this embodiment, the first micro LED panel 101 includes the first pixel units 11, 12, 13, and 14 arranged in an array. Each of the first pixel units 11, 12, 13, and 14 includes the first micro LEDs for emitting the first color light. The second micro LED panel 102 includes the second pixel units 21, 22, 23, and 24 arranged in an array. The second pixel unit 21 includes an upper unit 21U and a lower unit 21L. The second pixel unit 22 includes an upper unit 22U and a lower unit 22L. The second pixel unit 23 includes an upper unit 23U and a lower unit 23L. The second pixel unit 24 includes an upper unit 24U and a lower unit 24L. The upper units 21U, 22U, 23U, and 24U and the lower units 21L, 22L, 23L, and 24L are arranged in an array. The upper unit 21U and the lower unit 21L have the same area and completely overlap. The upper unit 22U and the lower unit 22L have the same area and completely overlap. The upper unit 23U and the lower unit 23L have the same area and completely overlap. The upper unit 24U and the lower unit 24L have the same area and completely overlap. Furthermore, each of the upper units 21U, 22U, 23U, and 24U includes the second micro LEDs for emitting the second color light. Each of the lower units 21L, 22L, 23L, and 24L includes the third micro LEDs for emitting the third color light. That is to say, in this embodiment, the second micro LEDs and the third micro LEDs are not disposed in the same layer.

As shown in FIG. 3A and FIG. 3B, the area of the first pixel unit 11 provided with the first micro LEDs is substantially equal to the area of the upper unit 22U provided with the second micro LEDs, and is also substantially equal to the area of the lower unit 22L provided with the third micro LEDs. Similarly, the area of the first pixel unit 12 provided with the first micro LEDs is substantially equal to the area of the upper unit 23U provided with the second micro LEDs, and is also substantially equal to the area of the lower unit 23L provided with the third micro LEDs. The area of the first pixel unit 13 provided with the first micro LEDs is substantially equal to the area of the upper unit 24U provided with the second micro LEDs, and is also substantially equal to the area of the lower unit 24L provided with the third micro LEDs. The area of the first pixel unit 14 provided with the first micro LEDs is substantially equal to the area of the upper unit 21U provided with the second micro LEDs, and is also substantially equal to the area of the lower unit 21L provided with the third micro LEDs. By stacking the upper units 21U, 22U, 23U, 24U and the lower units 21L, 22L, 23L, 24L one by one, a resolution of the projection device can be further improved.

Based on the above, in the projection device provided in the embodiment of the disclosure, the first micro LED panel includes the first micro LEDs providing the first color light. The second micro LED panel includes the second micro LEDs providing the second color light and the third micro LEDs providing the third color light. The first micro LED panel and the second micro LED panel are disposed on both sides of the color combiner prism to generate the image light by utilizing the light-combining function of the color combiner prism. Only one light combining element is required to be provided in the projection device, so the projection device has a small size and a low cost.

What is claimed is:

1. A projection device, comprising:
a first micro light emitting diode panel, comprising a plurality of first micro light emitting diodes arranged in an array;
a second micro light emitting diode panel, comprising a plurality of second micro light emitting diodes and a plurality of third micro light emitting diodes arranged in an array, wherein the plurality of first micro light emitting diodes, the plurality of second micro light emitting diodes, and the plurality of third micro light emitting diodes respectively emit a first color light, a second color light, and a third color light that are different from each other;
a color combiner prism, disposed on a path of the first color light, the second color light, and the third color light to generate an image light; and
a projection lens, disposed on a path of the image light, wherein the image light is emitted from the projection device after passing through the projection lens.

2. The projection device according to claim 1, wherein the first micro light emitting diode panel comprises a plurality of first pixel units, the second micro light emitting diode panel comprises a plurality of second pixel units, wherein the plurality of first pixel units respectively correspond to the plurality of second pixel units, each of the first pixel units comprises at least one of the first micro light emitting diodes, and each of the second pixel units comprises at least one of the second micro light emitting diodes and at least one of the third micro light emitting diodes.

3. The projection device according to claim 2, wherein an area of a region corresponding to the plurality of first micro light emitting diodes in each of the first pixel units is equal to an area of a region corresponding to the plurality of second micro light emitting diodes in each of the second pixel units.

4. The projection device according to claim 2, wherein an area of a region corresponding to the plurality of first micro light emitting diodes in each of the first pixel units is equal to an area of a region corresponding to the plurality of third micro light emitting diodes in each of the second pixel units.

5. The projection device according to claim 2, wherein a sum of an area of a region corresponding to the plurality of second micro light emitting diodes in each of the second pixel units and an area of a region corresponding to the plurality of third micro light emitting diodes in each of the second pixel units is equal to an area of a region corresponding to the plurality of first micro light emitting diodes in each of the first pixel units.

6. The projection device according to claim 5, wherein the first micro light emitting diodes panel further comprises a first control module, and the second micro light emitting diodes panel further comprises a second control module, wherein each of the first pixel units comprises a plurality of first sub-pixel units, each of the second pixel units comprises a plurality of second sub-pixel units, the first control module independently controls a current amount of each of the first sub-pixel units, and the second control module independently controls a current amount of each of the second sub-pixel units.
